(19) United States
(12) Patent Application Publication
(10) Pub. No.: US 2017/0291828 A1
(43) Pub. Date: Oct. 12, 2017

(54) METHOD FOR STABILIZATION OF ARSENIC

(71) Applicant: Dundee Sustainable Technologies Inc., Montreal (CA)

(72) Inventors: Jean-Marc Lalancette, Sherbrooke (CA); David Lemieux, Thetford Mines (CA); Romain Barbaroux, St-Joseph de Coleraine (CA)

(73) Assignee: Dundee Sustainable Technologies Inc., Montreal (CA)

(21) Appl. No.: 15/096,421

(22) Filed: Apr. 12, 2016

(51) Int. Cl. C01G 28/02; C25B 9/06; C25B 1/26

(52) U.S. Cl. CPC C01G 28/02; C25B 1/26; C25B 9/06

(57) ABSTRACT

A method for formation of scorodite and for stabilization of arsenic by formation of scorodite, comprising using sodium hypochlorite as an oxidizing agent. The method comprises producing sodium hypochlorite having a concentration in a range between 1 and 3 w/w % using a diaphragm-less electrolytic cell operating with a sodium salt solution having a salt concentration in a range between 2 and 10 w/w %; diluting a sodium hypochlorite solution to less than 1 w/w % in an arsenic solution at an oxydo reduction potential in a range between 900 and 1100 mV (Pt, AgCl reference) and a pH comprised in range between 0.5 and 2.0; contacting a resulting oxidized arsenic with a ferric salt; and raising the pH to 5.

### FIELD OF THE INVENTION

The present invention relates to stabilization of arsenic. More specifically, the present invention is concerned with a method for stabilization of arsenic by the formation of scorodite.

### BACKGROUND OF THE INVENTION

Arsenic is of frequent occurrence in a great variety of ores from gold rich arsenopyrite to copper bearing enargite. Processing of such ores, either by pyrometallurgy or hydrometallurgy, generates particulates, dusts or solutions tinted with arsenic, generally under the form of arsenious oxide (As₂O₃).

Current methods for the stabilization of such arsenic-containing toxic by-product call upon the combination of trivalent iron with pentavalent arsenic to form a low solubility ferric arsenate (FeAsO₄.2H₂O), i.e. an insoluble crystalline mineral called scorodite (FeAsO₄.2H2O). In order to obtain this insoluble ferric arsenate, the arsenic needs be oxidized to the pentavalent state and, if no ferric salt is available, the same oxidation is required on the iron. The current methods use chlorine or hydrogen peroxide as oxidizing agents in these oxidation reactions.

Chlorine or hydrogen peroxide as oxidizing agents represent a major contribution to the cost incurred by current methods for stabilization of arsenic as scorodite. Besides, these oxidizing agents suffer from significant drawbacks. Indeed, production and liquefaction of chlorine, which is used under the form of a liquefied gas under pressure, is costly, its transportation cumbersome and its storage not without danger. As for hydrogen peroxide, it is currently manufactured by the quinone hydroquinone process, which is a very complex process. In summary, these oxidizing agents are very costly, not being very stable and require special handling techniques. As a result, although leading to a relatively stable product at a pH around 5, the current methods for formation of scorodite are mortgaged by requirement of these costly and potentially aggressive oxidizing agents.

There is still a need in the art for a method for the stabilization of arsenic.

The present description refers to a number of documents, the content of which is herein incorporated by reference in their entirety.

### SUMMARY OF THE INVENTION

More specifically, in accordance with the present invention, there is provided a method for stabilization of arsenic by formation of scorodite, comprising using sodium hypochlorite as an oxidizing agent.

There is further provided a method for formation of scorodite, comprising using sodium hypochlorite as an oxidizing agent.

There is further provided a method for stabilization of arsenic, comprising producing sodium hypochlorite having a concentration in a range between 1 and 3 w/w % using a diaphragm-less electrolytic cell operating with a sodium salt solution having a salt concentration in a range between 2 and 10 w/w %; diluting a sodium hypochlorite solution to less than 1 w/w % in an arsenic solution at an oxydo reduction potential in a range between 900 and 1100 mV (Pt, AgCl reference) and a pH comprised in range between 0.5 and 2.0; contacting a resulting oxidized arsenic with a ferric salt; and raising the pH to 5.

Other objects, advantages and features of the present invention will become more apparent upon reading of the following non-restrictive description of specific embodiments thereof, given by way of example.

### DESCRIPTION OF ILLUSTRATIVE EMBODIMENTS

The present invention is illustrated in further details by the following non-limiting examples.

According to an embodiment of an aspect of the present invention, trivalent arsenic, and optionally divalent iron, is oxidized to pentavalent arsenic, and trivalent iron respectively, using sodium hypochlorite as an oxidizing agent

Sodium hypochlorite (NaOCl) is produced by reacting chlorine gas with sodium hydroxide. Chlorine gas and sodium hydroxide are usually obtained by the electrolysis of a highly purified brine in a cell with a diaphragm very sensitive to Ca/Mg ions.

Surprisingly, it was found that using a diaphragm-less electrolytic cell operating with diluted brine such as sea water, i.e. a sodium salt solution with a salt concentration in a range between about 2 and about 10 w/w %, could yield sodium hypochlorite at low concentrations, i.e. in a range between about 1 and about 3 w/w %, efficiently, thereby allowing producing a low cost oxidizing agent.

However, since in contrast to hydrogen peroxide or chlorine, which are very powerful oxidizing agents, sodium hypochlorite (NaOCl) is a weak oxidizing agent, it was not obvious that trivalent arsenic or ferrous iron could be oxidized to their maximum valencies with this weaker hypo agent. Surprisingly, it was found that using a 2 w/w % sodium hypochlorite solution diluted to less than about 1 w/w % in an arsenic solution, arsenious oxide was readily oxidized to arsenic oxide, the Oxydo Reduction Potential (ORP) of the mixture being in the range between about 900 and about 1100 mV (Pt, AgCl reference). In turn, this oxidized arsenic, when contacted with a ferric salt gave the expected hydrated ferric arsenate upon raising pH from about 1 to about 5, leaving the filtered solution with an arsenic content at the level of 1 ppm.

It was also found that a 2 w/w % hypo solution obtaining by using a diaphragm-less electrolytic cell operating with diluted brine such as sea water could readily oxidize the ferrous iron to ferric state.

The diaphragm-less electrolytic cell used was a commercial model developed for the production of low concentration hypo used in the treatment of waste waters.

Thus, using in situ production of diluted hypo from sea water or low concentration brines as substitute to chlorine or peroxide was found to decrease very significantly the cost of stabilization of arsenic by formation of scorodite.

The following example is given for illustration of the method.

Using a commercial diaphragm-less electrolytic cell from Severn Trent co with a rated capacity of 11.83 l/min of brine and a generating capacity of 5.6 Kg/h of sodium hypochlorite (NaOCl), a one cubic meter of brine at 8% sodium chlorine (NaCl) was circulated through three cells in series. After 85 minutes the one cubic meter of brine was measured with a 2.7 w/w % sodium hypochlorite (NaOCl) content. This solution was used as oxidizing agent for the production of scorodite. Following the water leaching of arsenical dusts, a solution having the following composition was obtained: As: 5410ppm; Cu: 5438 ppm; K: 7361 ppm, Zn: 1340 ppm; Cd: 628 ppm; Fe: 195 pmr. This solution (2.01) was oxidized with 400 ml of sodium hypochlorite (NaOCl) at 2 w/w %. The ORP was maintained at its original value of 1,100 mV for one hour at room temperature with stirring, the pH being 2.1. The excess hypo was then removed by addition of ferrous sulfate until the ORP was reduced to 400 mV. The iron content of the solution was adjusted by addition of ferric sulfate so as to obtain a Fe/As molar ratio of 2. Then the pH of the solution was raised to 5.0 by addition of sodium hydroxide (NaOH), causing the precipitation of ferric arsenate, which was then filtered off. The analysis of the solution showed an As content of one ppm, indicating an essentially complete removal of arsenic from the solution.

There is thus provided a method for the formation of scorodite where sodium hypochlorite is used as an oxidizing agent for the arsenious and/or ferrous species into pentavalent arsenic and/or trivalent iron respectively.

The production of sodium hypochlorite is done with a diaphragm-less electrolytic cell, using sea water or low concentration brines, i. e. a sodium salt solution with a salt concentration in a range between about 2 and about 10 w/w %

The sodium hypochlorite produced exists at a pH of about 0.5 to about 2.0 in the reaction media and has an ORP in a range between about 900 and about 1100 mV (Pt, AgCl reference). The sodium hypochlorite produced has a concentration in a range between about 1 and about 3 w/w % hypo.

There is therefore provided a method for stabilizing arsenic sing low concentration sodium hypochlorite generated in situ in a diaphragm-less electrolytic cell.

The scope of the claims should not be limited by the embodiments set forth in the examples, but should be given the broadest interpretation consistent with the description as a whole.

1. A method for stabilization of arsenic by formation of scorodite, comprising using sodium hypochlorite as an oxidizing agent.

2. The method of claim 1, comprising oxidizing at least one of: i) trivalent arsenic and ii) divalent iron into at least one of: i) pentavalent arsenic, and ii) trivalent iron respectively, using sodium hypochlorite.

3. The method of claim 1, comprising using sodium hypochlorite having a concentration in a range between 1 and 3 w/w %.

4. The method of claim 1, comprising producing sodium hypochlorite using a diaphragm-less electrolytic cell operating with a sodium salt solution having a salt concentration in a range between 2 and 10 w/w %.

5. The method of claim 1, comprising diluting a sodium hypochlorite solution to less than 1 w/w % in an arsenic solution at an oxydo reduction potential in a range between 900 and 1100 mV (Pt, AgCl reference) and a pH comprised in range between 0.5 and 2.0, contacting a resulting oxidized arsenic with a ferric salt and raising the pH to 5.

6. The method of claim 1, comprising producing sodium hypochlorite by electrolysis of one of: i) a sodium salt solution with a salt concentration in a range between 2 and 10 w/w %, and ii) sea water, in a diaphragm-less cell.

7. A method for formation of scorodite, comprising using sodium hypochlorite as an oxidizing agent.

8. The method of claim 7, comprising oxidizing at least one of: i) trivalent arsenic and ii) divalent iron into at least one of: i) pentavalent arsenic, and ii) trivalent iron respectively, using sodium hypochlorite.

9. The method of claim 7, comprising using sodium hypochlorite having a concentration in a range between 1 and 3 w/w %.

10. The method of claim 7, comprising producing sodium hypochlorite using a diaphragm-less electrolytic cell operating with a sodium salt solution having a salt concentration in a range between 2 and 10 w/w %.

11. The method of claim 7, comprising diluting a sodium hypochlorite solution to less than 1 w/w % in an arsenic solution at an oxydo reduction potential in a range between 900 and 1100 mV (Pt, AgCl reference) and a pH comprised in range between 0.5 and 2.0, contacting a resulting oxidized arsenic with a ferric salt and raising the pH to 5.

12. The method of claim 7, comprising producing sodium hypochlorite by electrolysis of one of: i) a sodium salt solution with a salt concentration in a range between 2 and 10 w/w %, and ii) sea water, in a diaphragm-less cell.

13. A method for stabilization of arsenic, comprising:
producing sodium hypochlorite having a concentration in a range between 1 and 3 w/w % using a diaphragm-less electrolytic cell operating with a sodium salt solution having a salt concentration in a range between 2 and 10 w/w %;
diluting a sodium hypochlorite solution to less than 1 w/w % in an arsenic solution at an oxydo reduction potential in a range between 900 and 1100 mV (Pt, AgCl reference) and a pH comprised in range between 0.5 and 2.0;
contacting a resulting oxidized arsenic with a ferric salt; and
raising the pH to 5.
